(19) United States
(12) Patent Application Publication
(10) Pub. No.: US 2003/0122331 A1
(43) Pub. Date: Jul. 3, 2003

(54) Cleaning cart

(75) Inventors: Alex P. DiGiacomo JR., Akron, OH (US); Douglas S. Hardesty, Akron, OH (US)

Correspondence Address: HAHN LOESER & PARKS, LLP, TWIN OAKS ESTATE, 1225 W. MARKET STREET, AKRON, OH, 44313, US

(73) Assignee: Akro-Mils, A Division of Myers Industries Inc

(21) Appl. No.: 10/345,509

(22) Filed: Jan. 16, 2003

Related U.S. Application Data
(63) Continuation-in-part of application No. 10/068,539, filed on Feb. 6, 2002.
(60) Provisional application No. 60/267,738, filed on Feb. 9, 2001.

(51) Int. Cl. B62B 3/00

(52) U.S. Cl. 280/47.35

(57) ABSTRACT

A compact cleaning cart for efficient cleaning that transports a vacuum cleaner, cleaning equipment, and a mop bucket or refuse container from the storeroom to the cleaning area, all in one trip. The compact size and contoured shape of the cleaning cart make it highly maneuverable in tight areas. The cleaning cart includes a rear vacuum cleaner platform for a vacuum cleaner and a front platform for a mop bucket or refuse container. A top shelf includes a zippered vinyl refuse bag to conceal trash. A plastic trash liner is preferably used within the vinyl refuse bag. A deep storage pocket, utility hooks, handle holes and handle slot, molded in top shelf, are provided for cleaning supplies, broom handles, bottles, dusters, etc.

This application is a continuation-in-part of co-pending application Ser. No. 10/068,539, filed Feb. 6, 2002, which claimed the benefit of provisional application serial No. 60/267,738, filed Feb. 9, 2001. The disclosures of application Ser. No. 10/068,539 and No. 60/267,738 are hereby incorporated by reference.

### BACKGROUND OF THE INVENTION

This invention relates generally to cleaning carts and in particular to wheeled, manually propelled cleaning carts where the cart can efficiently store and organize all the necessary implements for normal cleaning duties.

In typical prior art cleaning carts, the cart includes a mop bucket tray, usually the front portion of the cart, a central storage area for holding paper supplies, cleaning products and tools and a trash collection bag, usually hanging from a combination bag support and cart handle. One such cart is shown in U.S. Pat. No. 4,923,202 by Breveglieri et al. The combined trash bag support and handle can be a problem in that the cleaner's hands are inserted into the trash bag when pushing the cart. This can cause cross-contamination from the trash to the surfaces the cleaner is cleaning. By allowing the trash bag to hang freely from the rear of the cart, the cart can become unstable as the trash bag is filled, the bag itself can fail by tearing or ripping open due to the unsupported weight of the trash within the bag. A further problem that can happen is contamination of the paper goods due to the paper goods being stored on open shelving adjacent the mop bucket tray. Either when a mop bucket containing water is placed on the cart or when the cart is being moved, water in the bucket can spill out and damage the paper goods on the storage shelves. In addition, when a vacuum cleaner has been needed by the cleaning personnel, many prior art cleaning carts do not have any provision for vacuum cleaners. In some, a hook or wire support has been provided to attach a vacuum cleaner to the cleaning cart. In these arrangements, the vacuum cleaner is typically positioned outside the boundaries of the cleaning cart.

The foregoing illustrates limitations known to exist in present cleaning carts. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the present invention, this is accomplished by providing a manually propelled cleaning cart comprising: a base; a plurality of wheels attached to the base; two vertical supports attached to the base; and a top shelf attached to upper ends of the vertical supports.

In another aspect of the present invention, this is accomplished by providing a manually propelled cleaning cart comprising: a base; a pair of central wheels attached to the base; a pair of front swivel wheels attached to the base; a pair of side posts, a side post being attached to each side of the base, each side post being positioned at least partially over a central wheel; and a top shelf attached to upper ends of the side posts, the top shelf having a central trash receiving aperture therein, the base including a front portion extending forward from the side posts and a vacuum cleaner platform extending rearward from the side posts.

In yet another aspect of the present invention, this is accomplished by providing a manually propelled cleaning cart comprising: a base having a front, a rear and two sides, the front being curved from one side to the other side; a plurality of wheels attached to the base; two vertical supports attached to the base; and a top shelf attached to upper ends of the vertical supports, the top shelf having a front, a rear and two sides, the front being curved from one side to the other side.

In yet another aspect of the present invention, this is accomplished by providing a manually propelled cleaning cart comprising: a base; a pair of central wheels attached to the base; a pair of front swivel wheels attached to the base; a pair of side posts, a side post being attached to each side of the base, each side post being positioned at least partially over a central wheel; a top shelf attached to upper ends of the side posts, the top shelf having a central trash receiving aperture therein and a central slot in a rear surface thereof; a pair of hand grips extending from the rear surface of the top shelf, a hand grip being positioned on each side of the top shelf central slot, the base including a front portion extending forward from the side posts and a vacuum cleaner platform extending rearward from the side posts; and a vacuum cleaner positioned on the vacuum cleaner platform, a handle of the vacuum cleaner being positioned within the top shelf central slot.

In yet another aspect of the present invention, this is accomplished by providing a manually propelled cleaning cart comprising: a base; at least two pairs of wheels attached to the base; a trash holder attached to the base; and a vacuum cleaner positioned on the base.

The foregoing and other aspects will become apparent from the following detailed description of the invention when considered in conjunction with the accompanying drawing figures.

### BRIEF DESCRIPTION OF THE DRAWING FIGURES

FIG. 1 is a front perspective view of a cleaning cart according to the present invention;

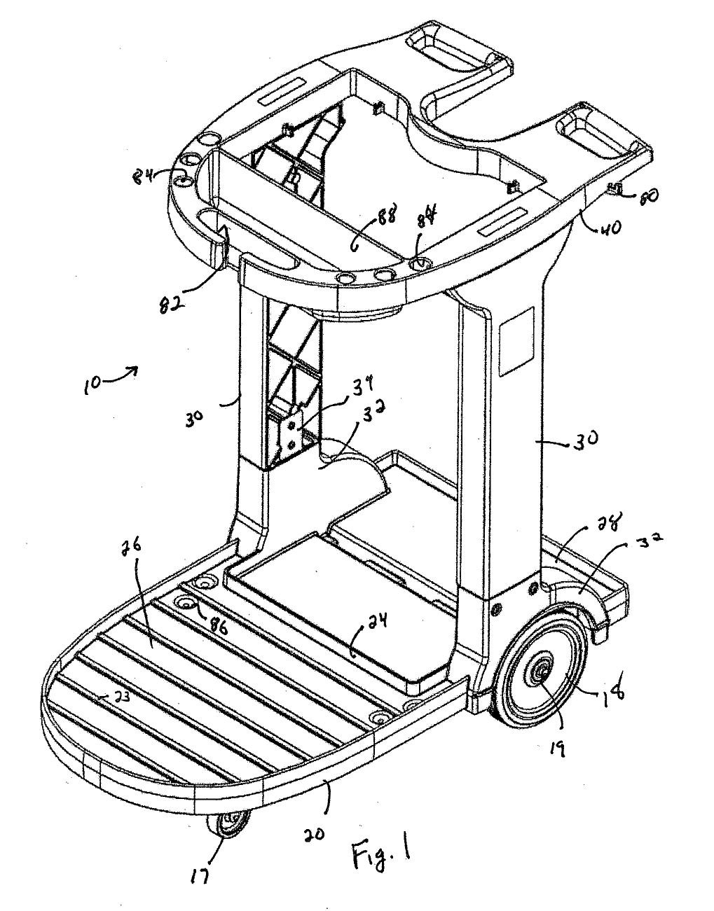

FIG. 2 is a rear perspective view of the cleaning cart shown in FIG. 1;

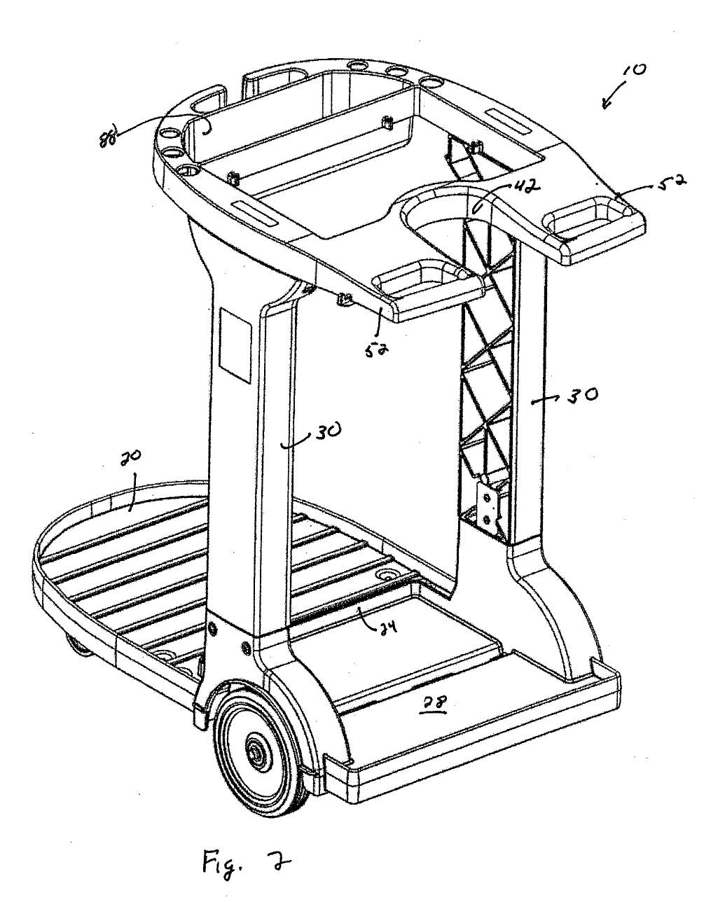

FIG. 3 is a perspective view of the cleaning cart shown in FIG. 1 showing a vinyl trash bag attached to the cleaning cart;

FIG. 4 is a top view of the cleaning cart shown in FIG. 1; and

FIG. 5 is a rear perspective view of the cleaning cart shown in FIG. 1, illustrating the placement of a vacuum cleaner on a base platform of the cleaning cart.

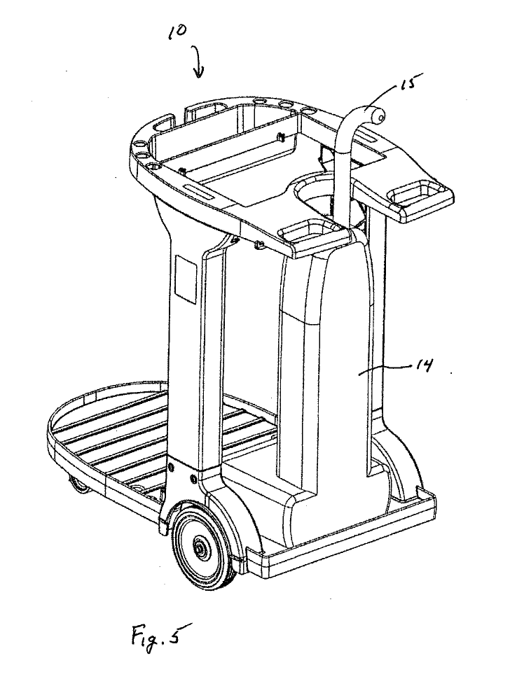

### DETAILED DESCRIPTION

The FIGURES show a compact cleaning cart 10 for efficient cleaning that transports a vacuum cleaner, cleaning equipment, and a mop bucket or refuse container from the storeroom to the cleaning area, all in one trip. The compact size and contoured shape of the cleaning cart 10 make it highly maneuverable in tight areas. The cleaning cart 10 includes a rear vacuum cleaner platform 28 for a vacuum cleaner 14 and a front platform 26 for a mop bucket (not shown) or refuse container (not shown). A top shelf 40 includes a zippered vinyl refuse bag 46 to conceal trash. A plastic trash liner (not shown) is preferably used within the vinyl refuse bag 46. A deep storage pocket 88, utility hooks 80, handle holes 84 and handle slot 82, molded in top shelf 40, are provided for cleaning supplies, broom handles, bottles, dusters, etc.

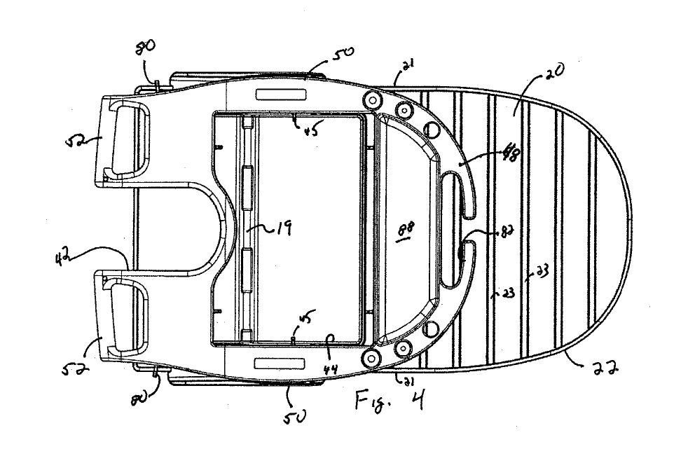

Attached to a base 20 are a pair of large rear wheels 18 and a pair of front swivel wheels 17. Base 20 is divided into two portions, a front platform 26 and a rear vacuum cleaner platform 28. Preferably, a raised water dam 24 is provided to keep spilled water on the front platform 26 from moving to the vacuum cleaner platform 28. The front platform 26 includes a plurality of ribs 23, which keep a mop bucket from moving around when cleaning cart 10 is moved. The front 22 of base 20 is curved from one base side 21 to the other base side 21 (see FIG. 4). Two base extensions 32 extend upward from the sides of the base 20. A side post 30 is attached to each base extension 32. Prior to attachment of the side posts 30 to base 20, an L-shaped support bracket 34 is inserted into each base extension 32. The rear wheels 18 are attached to an axle 19, which is inserted through a hole (not shown) in the lower end of each support bracket 34. Side posts 30 are attached by screws to both the base extensions 32 and the support bracket 34.

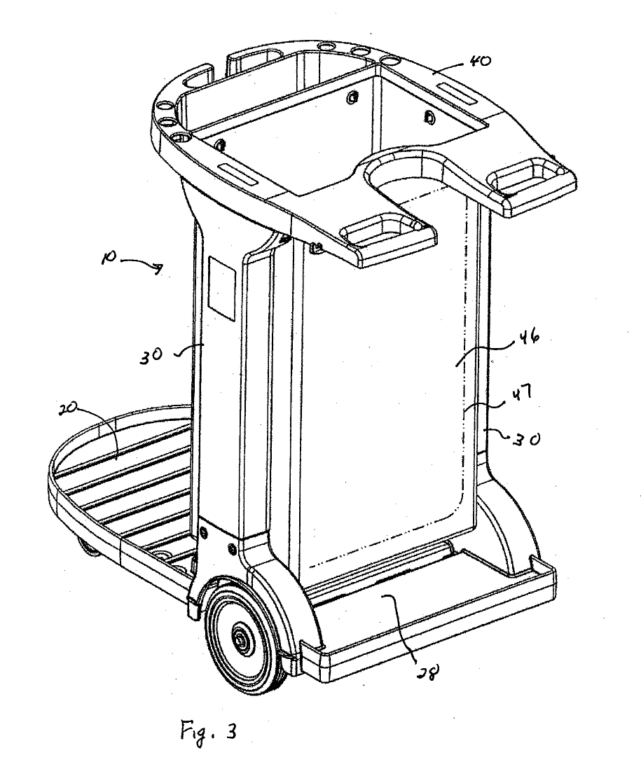

Preferably, only two side posts 30 are provided with each side post 30 being positioned along a side 21 of base 20, partially over rear wheels 18 and extending forward of wheels 18. The top shelf 40 is attached to the upper ends of side posts 30. Top shelf 40 is cantilevered forward and rearward of side posts 30. A trash receiving aperture 44 is formed in the middle of top shelf 40. Vinyl refuse bag 46 is attached to top shelf 40 using a plurality of bag retainers or hooks 45 positioned about the inside edge of trash receiving aperture 44. Other methods of attaching vinyl refuse bag 46 can be used, such as Velcro® fasteners or elastic bands. Vinyl refuse bag 46 has a zipper 47 in one side (see FIG. 3). Preferably, a plastic trash bag (not shown) is used inside of vinyl refuse bag 46. Alternatively, a plastic trash bag can be attached to top shelf 40 without using the vinyl refuse bag 46.

Top shelf 40 includes a variety of storage devices for holding cleaning supplies and tools. A plurality of storage or tool handle holes 84 are formed in top shelf 40 to hold various cleaning tools, such as dry mops, brooms, feather dusters, etc. A bottom tool support 86, in the form a circular depression is provided in base 20 directly below some of the storage holes 84. The handle of a long broom can be placed through a storage hole 84 and the tip of the handle is supported and held within bottom tool support 86. This helps prevent such long handled tools from tipping while cleaning cart 10 is being moved. A storage hook 80 extends outward from each side 50 of top shelf 40. A deep storage pocket 88 is formed in the front part of top shelf 40. Also in the front part of top shelf 40 is a slot 82, which can be used for mop handles. When cleaning cart 10 is used with a mop bucket, the mop bucket can be placed on the base front platform 26 with the mop in the mop bucket. The mop handle is inserted into slot 82, thereby holding the mop handle while cleaning cart 10 is moved, without having to remove the mop from the mop bucket.

Similar to base 20, the front 48 of top shelf 40 is curved from one side 50 of the top shelf 40 to the other side 50. The radius of curvature of top shelf curved front 48 is similar to the radius of curvature of base curved front 22.

A pair of spaced apart hand grips 52 project from the rear of top shelf 40. The hand grips 52 are spaced away from the central trash receiving aperture 44. A central slot 42 is formed in the rear edge of top shelf 40 between hand grips 52. The vacuum cleaner handle 15 fits within slot 42.

Having described the invention, what is claimed is:

1. A manually propelled cleaning cart comprising:
a base;
a plurality of wheels attached to the base;
two vertical supports attached to the base; and
a top shelf attached to upper ends of the vertical supports.

2. The manually propelled cleaning cart according to claim 1, wherein the top shelf has a central trash receiving aperture therein.

3. The manually propelled cleaning cart according to claim 2, wherein the top shelf has trash bag retainers thereon, the trash bag retainers being adapted to attach a trash bag to the top shelf.

4. The manually propelled cleaning cart according to claim 3, wherein the trash bag retainers comprise a plurality of hooks positioned about an interior surface of the central trash receiving aperture.

5 The manually propelled cleaning cart according to claim 2, wherein the central trash receiving aperture extends both forward and rearward of the vertical posts.

6. The manually propelled cleaning cart according to claim 1, wherein the number of wheels is four, the wheels being arranged in a set of two rear wheels and a set of two front wheels.

7. The manually propelled cleaning cart according to claim 6, wherein the vertical supports are positioned forward from the set of rear wheels.

8. The manually propelled cleaning cart according to claim 7, wherein the portion of the base between the vertical supports and a rear of the base defines a vacuum cleaner platform.

9. The manually propelled cleaning cart according to claim 8, further comprising a vacuum cleaner positioned on the vacuum cleaner platform.

10. The manually propelled cleaning cart according to claim 9, wherein a portion of the vacuum cleaner is positioned vertically under the top shelf central trash receiving aperture.

11. The manually propelled cleaning cart according to claim 1, wherein a front of the base is curved from a first side of the base to a second side of the base.

12. The manually propelled cleaning cart according to claim 11, wherein a front of the top shelf is curved from a first side of the top shelf to a second side of the top shelf.

13. The manually propelled cleaning cart according to claim 1, wherein a front of the top shelf is curved from a first side of the top shelf to a second side of the top shelf.

14. The manually propelled cleaning cart according to claim 1, wherein there are two and only two vertical supports.

15. The manually propelled cleaning cart according to claim 1, further comprising a water dam attached to the base.

16. The manually propelled cleaning cart according to claim 15, wherein the water dam divides the base into a front portion and a rear portion.

17. The manually propelled cleaning cart according to claim 1, further comprising two spaced apart hand grips extending from a rear surface of the top shelf.

18. The manually propelled cleaning cart according to claim 1, wherein the top shelf includes a plurality of storage devices.

19. The manually propelled cleaning cart according to claim 18, wherein the plurality of storage devices are selected from the group consisting of a hook, a slot, an aperture and a storage pocket.

20. The manually propelled cleaning cart according to claim 1, wherein the top shelf has a central slot in a rear surface thereof.

21. The manually propelled cleaning cart according to claim 20, further comprising a pair of hand grips extending from a rear surface of the top shelf, a hand grip being positioned on each side of the central slot.

22. The manually propelled cleaning cart according to claim 1, wherein the base includes a front portion extending forward of the vertical posts.

23. The manually propelled cleaning cart according to claim 1, wherein a vertical post is attached to each side of the base.

24. The manually propelled cleaning cart according to claim 1, wherein the top shelf is cantilevered from the vertical supports and extends horizontally forward and rearward from the vertical supports.

25. A manually propelled cleaning cart comprising:
a base;
a pair of central wheels attached to the base;
a pair of front swivel wheels attached to the base;
a pair of side posts, a side post being attached to each side of the base, each side post being positioned at least partially over a central wheel; and
a top shelf attached to upper ends of the side posts, the top shelf having a central trash receiving aperture therein,
the base including a front portion extending forward from the side posts and a vacuum cleaner platform extending rearward from the side posts.

26. The manually propelled cleaning cart according to claim 25, further comprising a vacuum cleaner positioned on the vacuum cleaner platform.

27. The manually propelled cleaning cart according to claim 26, wherein a portion of the vacuum cleaner extends below the central trash receiving aperture.

28. The manually propelled cleaning cart according to claim 25, further comprising a water dam separating the base front portion from the vacuum cleaner portion.

29. The manually propelled cleaning cart according to claim 25, wherein a portion of each side post is positioned forward of the central wheels.

30. The manually propelled cleaning cart according to claim 25, wherein a front of the base is curved from a first side of the base to a second side of the base and a front of the top shelf is curved from a first side of the top shelf to a second side of the top shelf.

31. The manually propelled cleaning cart according to claim 30, wherein the radius of curvature of the base curved front is similar to the radius of curvature of the top shelf curved front.

32. The manually propelled cleaning cart according to claim 25, further comprising two spaced apart hand grips extending from a rear surface of the top shelf.

33. The manually propelled cleaning cart according to claim 25, wherein the top shelf has a central slot in a rear surface thereof, and further comprising a pair of hand grips extending from the rear surface of the top shelf, a hand grip being positioned on each side of the central slot.

34. A manually propelled cleaning cart comprising:
a base having a front, a rear and two sides, the front being curved from one side to the other side;
a plurality of wheels attached to the base;
two vertical supports attached to the base; and
a top shelf attached to upper ends of the vertical supports, the top shelf having a front, a rear and two sides, the front being curved from one side to the other side.

35. The manually propelled cleaning cart according to claim 34, wherein the radius of curvature of the base curved front is similar to the radius of curvature of the top shelf curved front.

36. The manually propelled cleaning cart according to claim 34, wherein the top shelf has a central trash receiving aperture therein.

37. The manually propelled cleaning cart according to claim 34, further comprising two spaced apart hand grips extending from a rear surface of the top shelf.

38. The manually propelled cleaning cart according to claim 34, wherein the top shelf has a central slot in a rear surface thereof.

39. The manually propelled cleaning cart according to claim 34, further comprising a water dam separating the base into a front portion and a rear portion.

40. A manually propelled cleaning cart comprising:
a base;
a pair of central wheels attached to the base;
a pair of front swivel wheels attached to the base;
a pair of side posts, a side post being attached to each side of the base, each side post being positioned at least partially over a central wheel;
a top shelf attached to upper ends of the side posts, the top shelf having a central trash receiving aperture therein and a central slot in a rear surface thereof;
a pair of hand grips extending from the rear surface of the top shelf, a hand grip being positioned on each side of the top shelf central slot,
the base including a front portion extending forward from the side posts and a vacuum cleaner platform extending rearward from the side posts; and
a vacuum cleaner positioned on the vacuum cleaner platform, a handle of the vacuum cleaner being positioned within the top shelf central slot.

41. The manually propelled cleaning cart according to claim 40, further comprising a water dam separating the base front portion from the base vacuum cleaner portion.

42. A manually propelled cleaning cart comprising:
a base;
at least two pairs of wheels attached to the base;
a trash holder attached to the base; and
a vacuum cleaner positioned on the base.

43. The manually propelled cleaning cart according to claim 42, wherein at least a portion of the vacuum cleaner is positioned vertically under the trash holder.

44. The manually propelled cleaning cart according to claim 42, wherein at least a portion of the vacuum cleaner is positioned over a line extending through one pair of wheels.

45. The manually propelled cleaning cart according to claim 42, wherein the trash holder has a slot therein, a handle of the vacuum cleaner being positioned within the slot.

46. The manually propelled cleaning cart according to claim 42, wherein the trash holder and at least a portion of the vacuum cleaner are positioned over a line extending through one pair of wheels.

47. The manually propelled cleaning cart according to claim 42, wherein the base includes a vertically extending water dam separating the base into a front platform and a vacuum cleaner platform.

48. The manually propelled cleaning cart according to claim 42, wherein the base includes a front portion extending forward of the trash holder and a rear portion extending rearward of the trash holder, the vacuum cleaner being rearward of the trash holder.
